(19) United States
(12) Patent Application Publication
(10) Pub. No.: US 2025/0258337 A1
(43) Pub. Date: Aug. 14, 2025

(54) BI-MATERIAL MODE MULTIPLEXER

(71) Applicant: Cisco Technology, Inc., San Jose, CA (US)

(72) Inventors: Dominic F. SIRIANI, Lansdale, PA (US); Jean-Luc J. TAMBASCO, Macungie, PA (US)

(21) Appl. No.: 18/441,877

(22) Filed: Feb. 14, 2024

(51) Int. Cl. G02B 6/122; G02B 6/12

(52) U.S. Cl. CPC G02B 6/1228; G02B 2006/12061

(57) ABSTRACT

The present disclosure describes a mode multiplexer with layered optical waveguides formed using different materials. The mode multiplexer includes a first optical waveguide and a second optical waveguide. The first optical waveguide includes a first end and a second end. The first end is wider than the second end. The second optical waveguide includes a third end. The second optical waveguide has a higher index of refraction than the first optical waveguide. The first optical waveguide and the second optical waveguide are arranged such that when the first optical waveguide and the second optical waveguide are viewed along a first axis: a length of the first optical waveguide and a length of the second optical waveguide extend along a second axis orthogonal to the first axis, the first end is non-overlapping with the third end, and the second optical waveguide partially overlaps the second end.

### TECHNICAL FIELD

Embodiments presented in this disclosure generally relate to optical communications. More specifically, embodiments disclosed herein relate to a mode multiplexer.

### BACKGROUND

Optical systems may use mode multiplexers to combine different optical signals onto a single waveguide. For example, the mode multiplexers may combine optical signals on separate optical waveguides onto a multimode optical waveguide. The optical signals may then propagate through the multimode optical waveguide with different modes. For the mode multiplexer to work properly, there should be low modal crosstalk between the optical signals. Existing mode multiplexers reduce the modal crosstalk by increasing the length of the mode multiplexers, which increases the size and cost of the mode multiplexers. For example, some mode multiplexers may be 200 to 400 micrometers (μm) in length.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example mode multiplexer in the system of FIG. 1.

FIG. 3 illustrates an example cross-section of a mode multiplexer in the system of FIG. 1.

FIG. 4 illustrates an example cross-section of a mode multiplexer in the system of FIG. 1.

FIG. 5 illustrates an example cross-section of a mode multiplexer in the system of FIG. 1.

FIG. 6 illustrates example cross-sections of a mode multiplexer in the system of FIG. 1.

FIG. 7 illustrates example cross-sections of a mode multiplexer in the system of FIG. 1.

FIG. 8 is a flowchart of an example method performed by the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a mode multiplexer with layered optical waveguides formed using different materials. According to an embodiment, a mode multiplexer includes a first optical waveguide and a second optical waveguide. The first optical waveguide includes a first end and a second end. The first end is wider than the second end. The second optical waveguide includes a third end. The second optical waveguide has a higher index of refraction than the first optical waveguide. The first optical waveguide and the second optical waveguide are arranged such that when the first optical waveguide and the second optical waveguide are viewed along a first axis: a length of the first optical waveguide and a length of the second optical waveguide extend along a second axis orthogonal to the first axis, the first end is non-overlapping with the third end, and the second optical waveguide partially overlaps the second end.

According to another embodiment, a method includes directing an optical signal in a first optical waveguide comprising a first end and a second end. The first end is wider than the second end. The method also includes optically coupling the optical signal into a second optical waveguide comprising a third end. The second optical waveguide has a higher index of refraction than the first optical waveguide. The first optical waveguide and the second optical waveguide are arranged such that when the first optical waveguide and the second optical waveguide are viewed along a first axis: a length of the first optical waveguide and a length of the second optical waveguide extend along a second axis orthogonal to the first axis, the first end is non-overlapping with the third end, and the second optical waveguide partially overlaps the second end.

According to another embodiment, a mode multiplexer includes a silicon nitride waveguide and a silicon waveguide. The silicon nitride waveguide includes a first end and a second end. The first end is wider than the second end. The silicon nitride waveguide and the silicon waveguide are arranged such that an optical signal propagating from the first end towards the second end in the silicon nitride waveguide optically couples into the silicon waveguide. A width of the second end prevents the optical signal from propagating to the second end.

### EXAMPLE EMBODIMENTS

The present disclosure describes a mode multiplexer with layered optical waveguides formed using different materials. For example, the mode multiplexer may include a first optical waveguide and a second optical waveguide positioned in a lower layer than the first optical waveguide. The first optical waveguide and the second optical waveguide may have different indexes of refraction. The first and second optical waveguides may gradually overlap along the lengths of the first and second optical waveguides. The first optical waveguide may taper such that the first optical waveguide does not support the mode of an optical signal at the output of the first optical waveguide. The second optical waveguide may widen such that the second optical waveguide supports multiple modes at the output of the second optical waveguide. An optical signal propagating through the first optical waveguide may optically couple into the second optical waveguide as the first optical waveguide and the second optical waveguide begin to gradually overlap.

In certain embodiments, the mode multiplexer presents several technical advantages. For example, because the first optical waveguide and the second optical waveguide have different indexes of refraction, the mode multiplexer reduces modal crosstalk relative to existing mode multiplexers. As a result, the mode multiplexer may be more compact (e.g., 60 μm in length) relative to existing mode multiplexers. In some tests, the mode multiplexer provides less than −36 dB of loss or crosstalk at 1310 nanometers (nm) for devices longer than 40 μm. For a 60 μm device, loss or crosstalk may be low across an entire 1260 to 1340 nm wavelength band.

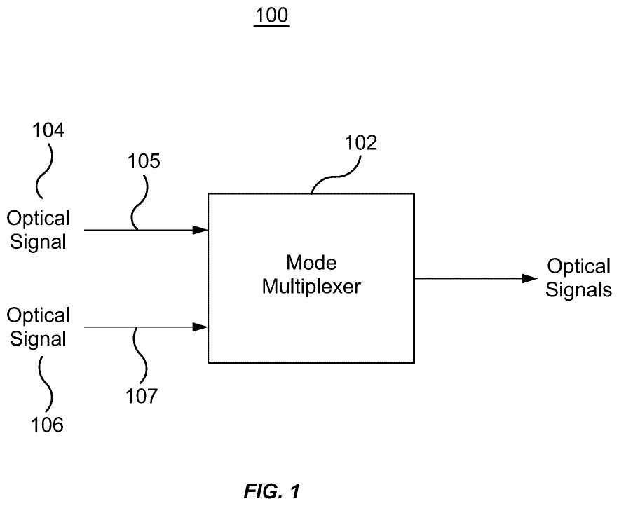

FIG. 1 illustrates an example system 100. The system 100 may be an optical circuit or device (e.g., a portion of an optical transceiver). As seen in FIG. 1, the system 100 includes a mode multiplexer 102. Generally, the mode multiplexer 102 combines one or more optical signals onto a single optical waveguide.

The mode multiplexer 102 receives an optical signal 104 over a waveguide 105 and an optical signal 106 over a waveguide 107. The mode multiplexer 102 then combines and outputs the optical signals 104 and 106 over a single waveguide. For example, the mode multiplexer 102 may combine the optical signals over the waveguide 107 by optically coupling the optical signal 104 to the waveguide 107. The mode multiplexer 102 then outputs the optical signals 104 and 106 over the waveguide 107. The optical signals 104 and 106 may have different modes over the waveguide 107. For example, the optical signal 104 may have a single lobe mode, and the optical signal 106 may have a two lobe mode. The waveguide 107 may support multiple modes. Additionally, the waveguides 105 and 107 may be formed using different materials that have different indexes of refraction, which reduces modal crosstalk while reducing the length of the mode multiplexer 102 relative to existing mode multiplexers. In certain embodiments, the mode multiplexer 102 may reduce modal crosstalk relative to existing mode multiplexers while having a length around 60 μm.

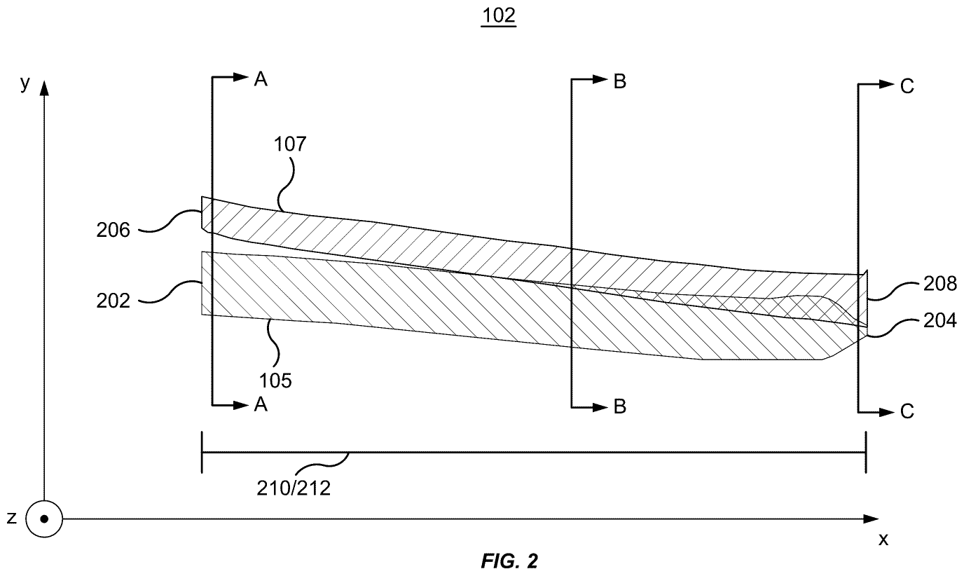

FIGS. 2 through 5 illustrate a design of the mode multiplexer 102. Although FIGS. 2 through 5 show the mode multiplexer 102 including two optical waveguides 105 and 17, the mode multiplexer 102 may include any number of optical waveguides, and the mode multiplexer 102 may combine any number of optical signals over the optical waveguides onto a single waveguide. Generally, the shapes and arrangement of the optical waveguides in the mode multiplexer 102 allow optical signals in one optical waveguide 105 to optically couple into the other optical waveguide 107.

The mode multiplexer 102 will be described using the x, y, and z axes shown in FIG. 2. These axes are orthogonal to each other and will establish the orientation of the components of the mode multiplexer 102. In the example of FIG. 2, the x axis extends towards the right, the y axis extends upwards, and the z axis extends out of the page. FIG. 2 shows the mode multiplexer 102 when viewed along the z axis.

As seen in FIG. 2, the mode multiplexer 102 includes the waveguide 105 and the waveguide 107. The waveguide 105 includes an end 202 and an end 204 opposite the end 202. The waveguide 107 includes an end 206 and an end 208 opposite the end 206. Additionally, the waveguide 105 has a length 210, and the waveguide 107 has a length 212. The waveguides 105 and 107 are arranged such that the lengths 210 and 212 extend along the x axis.

The waveguide 105 and the waveguide 107 may be made using different materials such that the waveguides 105 and 107 have different indexes of refraction. For example, the waveguide 105 may be formed using silicon nitride, and the waveguide 107 may be formed using silicon. The different indexes of refraction may reduce modal crosstalk between the waveguides 105 and 107.

An optical signal may be input into the waveguide 105 at the end 202. The waveguide 105 may then direct the optical signal towards the end 204. Both the waveguides 105 and 107 may be wide enough to support a single mode at the ends 202 and 206. As seen in FIG. 2, the waveguide 105 tapers from the end 202 to the end 204. Specifically, the waveguide 105 narrows such that the end 202 is wider than the end 204 along the y axis. In some embodiments, the waveguide 105 narrows such that the end 204 does not support any modes of an optical signal, which may prevent an optical signal from propagating to the end 204. Likewise, the waveguide 107 receives an optical signal at the end 206 and directs the optical signal towards the end 208. The waveguide 107, however, widens such that the end 208 is wider than the end 206 along the y axis. In some embodiments, the waveguide 107 widens such that the end 208 supports multiple modes.

The waveguides 105 and 107 are arranged such that the waveguides 105 and 107 gradually overlap with each other along the lengths 210 and 212. Specifically, the waveguides 105 and 107 may be positioned at different heights along the z axis. For example, the waveguide 105 may be positioned higher than the waveguide 107 along the z axis. When viewed along the z axis, the end 202 is non-overlapping with the end 206. Stated differently, the end 202 does not have the same coordinates on the y axis or the z axis as the end 206. In some embodiments, the end 202 is aligned with the end 206 even though the ends 202 and 206 are non-overlapping. For example, the end 202 shares the same coordinates on the x axis as the end 206, and the end 202 does not share the same coordinates on the y axis as the end 206.

Additionally, when viewed along the z axis, the end 204 partially overlaps the end 208. Portions of the waveguide 105 also overlap portions of the waveguide 107 moving along the lengths 210 and 212 towards the ends 204 and 208. Stated differently, these overlapping portions, including the ends 204 and 208, share the same coordinates on the y axis. This partial overlap may be gradual, and may be referred to as an adiabatic overlap. In some embodiments, the ends 204 and 208 are aligned. Stated differently, the end 204 shares the same coordinates on the x axis as the end 206.

As an optical signal is directed through the waveguide 105 from the end 202 towards the end 204, the optical signal may optically couple into the waveguide 107. None of the optical signal may remain in the waveguide 105 near the end 204 (e.g., because the waveguide 105 tapers such that the end 204 does not support any mode of an optical signal). As a result, the mode multiplexer 102 optically couples an optical signal in the waveguide 105 into the waveguide 107. The mode multiplexer 102 then outputs the optical signal at the end 208 of the waveguide 107.

As an example, the waveguide 105 may be a low index waveguide formed using silicon nitride. An optical signal may be input at the end 202 of the waveguide 105 in the first transverse electric (TE₀) mode. The waveguide 107 may be a higher index, multimode waveguide formed using silicon. The gradual overlap of the waveguides 105 and 107 may cause the optical signal to adiabatically transfer from the waveguide 105 to the waveguide 107 in the second transverse electric (TE₁) mode. The optical signal may then be output at the end 208 of the waveguide 107. In this manner, the mode multiplexer 102 provides low modal crosstalk due to the effective indices of TE₀ and TE₁ are different when the multiplexing occurs. Additionally, using silicon in the multiplexing process provides for a more compact device (e.g., 60 μm in length).

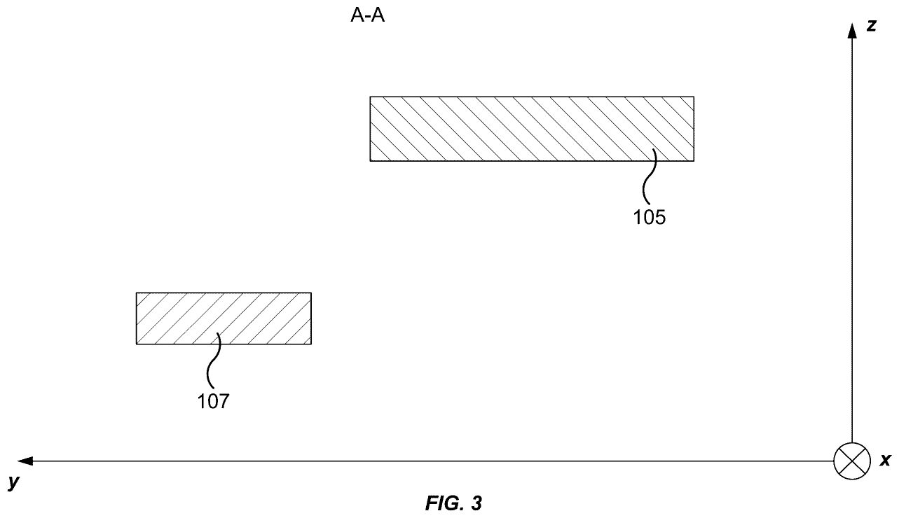

FIG. 3 illustrates a cross-sectional view of the mode multiplexer 102. Specifically, FIG. 3 shows the cross-section labeled as A-A in FIG. 2, which is near the ends 202 and 206 of the waveguides 105 and 107. As seen in FIG. 3, the waveguides 105 and 107 are positioned according to the x, y, and z axes. The waveguide 105 is positioned higher than the waveguide 107 along the z axis. Additionally, the waveguides 105 and 107 are non-overlapping when viewed along the z axis. Specifically, the waveguides 105 and 107 do not share the same coordinates along the y axis. Furthermore, the waveguide 105 is wider than the waveguide 107 along the y axis.

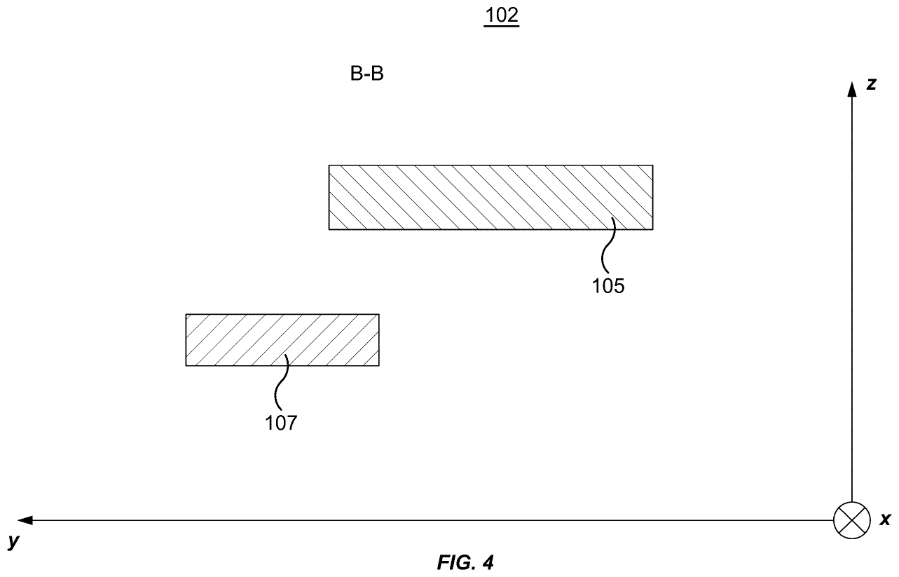

FIG. 4 shows a cross-sectional view of the mode multiplexer 102 at the cross-section labeled B-B in FIG. 2, which is around the middle of the waveguides 105 and 107 (or between the ends 202 and 204 and the ends 206 and 208). As seen in FIG. 4, the waveguides 105 and 107 are positioned according to the x, y, and z axes. The waveguide 105 is positioned higher than the waveguide 107 along the z axis. Additionally, the waveguides 105 and 107 partially overlap each other when viewed along the z axis. Specifically, portions of the waveguides 105 and 107 have the same coordinate on the y axis. Because of this partial overlap, an optical signal in the waveguide 107 may optically couple into the waveguide 105 near the cross-section B-B.

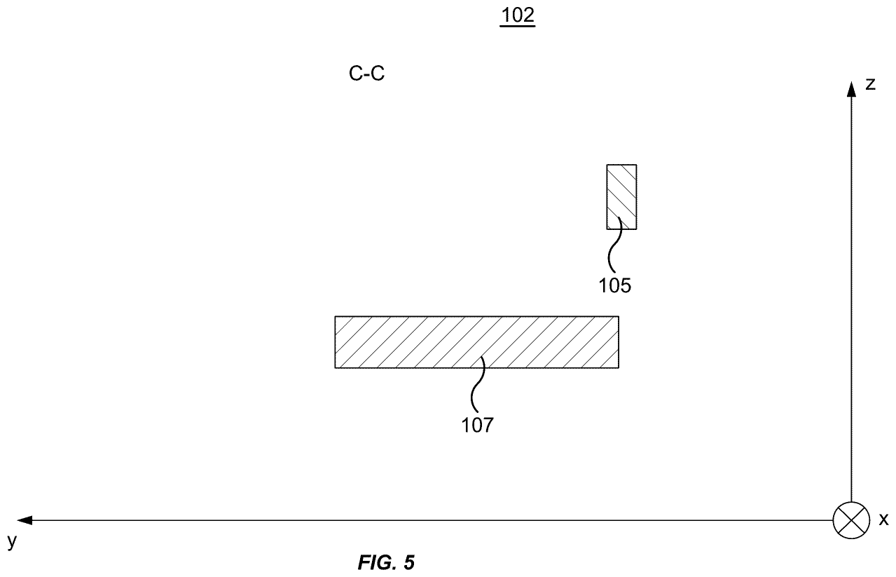

FIG. 5 shows a cross-sectional view of the mode multiplexer 102 at the cross-section labeled C-C in FIG. 2, which is near the ends 204 and 208 of the waveguides 105 and 107. As seen in FIG. 5, the waveguides 105 and 107 are positioned according to the x, y, and z axes. The waveguide 105 is positioned higher than the waveguide 107 along the z axis. Additionally, the waveguides 105 and 107 partially overlap each other when viewed along the z axis. Specifically, portions of the waveguides 105 and 107 have the same coordinates on the y axis.

Furthermore, the widths of the waveguides 105 and 107 along the y axis have changed from the other cross-sectional views. For example, in FIG. 5, the waveguide 107 is wider than the waveguide 105 along the y axis. In the cross-sectional view A-A shown in FIG. 3, the waveguide 105 is wider than the waveguide 107 along the y axis. Stated differently, along the lengths 210 and 212 of the waveguides 105 and 107, the waveguide 105 has tapered and narrowed such that the width of the waveguide 105 along the y axis reduces along the length 210 of the waveguide 105. The width of the waveguide 107 increases along the length 212 of the waveguide 107. In some embodiments, the waveguide 105 tapers or narrows such that the narrow end 204 of the waveguide 105 does not support any modes of an optical signal. As a result, an optical signal directed through the waveguide 105 may optically couple completely into the waveguide 107 such that none of the optical signal remains in the waveguide 105 near the end 204 of the waveguide 105.

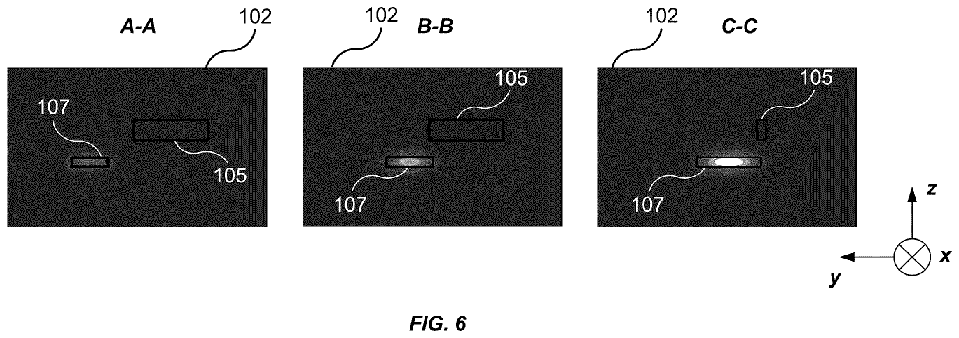

FIG. 6 shows cross-sectional views of the mode multiplexer 102. Specifically, FIG. 6 shows the cross-sectional views A-A, B-B, and C-C as an optical signal is directed through the waveguide 107. The waveguides 105 and 107 are positioned according to the x, y, and z axes.

The cross-section A-A shows the waveguides 105 and 107 near the ends 202 and 206 of the waveguides 105 and 107. As seen in the cross-sectional view A-A, the waveguide 105 is positioned higher than the waveguide 107 on the z axis. Additionally, the waveguides 105 and 107 are non-overlapping when viewed along the z axis (e.g., the waveguides 105 and 107 do not share the same coordinates on the y axis). An optical signal is input into the waveguide 107.

The cross-section B-B shows the waveguides 105 and 107 around the middle (or somewhere between the ends 202 and 204 and the ends 206 and 208) of the waveguides 105 and 107. As seen in the cross-section B-B, the waveguide 105 is positioned higher than the waveguide 107 on the z axis. Additionally, the waveguides 105 and 107 partially overlap each other when viewed along the z axis (e.g., portions of the waveguides 105 and 107 share the same coordinates on the y axis). The optical signal continues to be directed through the waveguide 107.

The cross-section C-C shows the waveguides 105 and 107 near the ends 204 and 208 of the waveguides 105 and 107. As seen in the cross-section C-C, the waveguide 105 is positioned higher than the waveguide 107 on the z axis. Additionally, the waveguides 105 and 107 partially overlap each other when viewed along the z axis (e.g., portions of the waveguides 105 and 107 share the same coordinates on the y axis). Furthermore the optical signal continues to be directed through the waveguide 107.

As shown in FIG. 6, the mode multiplexer 102 directs the optical signal input to the waveguide 107 through the waveguide 107. The optical signal may have a single mode, and the waveguide 107 may maintain that single mode as the optical signal is directed through the waveguide 107.

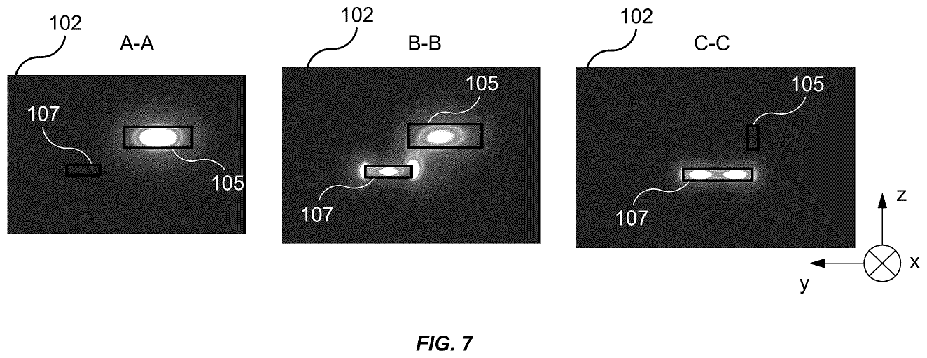

FIG. 7 illustrates cross-sectional views of the mode multiplexer 102. Specifically, FIG. 7 shows the cross-sections A-A, B-B, and C-C as an optical signal is directed into the waveguide 105. As seen in FIG. 7, the waveguides 105 and 107 are positioned according to the x, y, and z axes.

The cross-section A-A shows the waveguides 105 and 107 near the ends 202 and 206 of the waveguides 105 and 107. The waveguide 105 is positioned higher than the waveguide 107 on the z axis. Additionally, the waveguides 105 and 107 do not overlap each other when viewed along the z axis (e.g., the waveguides 105 and 107 do not share the same coordinates on the y axis). An optical signal is input into the waveguide 105. As seen in FIG. 7, the optical signal has a single lobe when input into the waveguide 105.

The cross-section B-B shows the waveguides 105 and 107 near the middle (or somewhere between the ends 202 and 204 and the ends 206 and 208) of the waveguides 105 and 107. The waveguide 105 is positioned higher than the waveguide 107 on the z axis. Additionally, the waveguides 105 and 107 partially overlap each other when viewed along the z axis (e.g., portions of the waveguides 105 and 107 share the same coordinates on the y axis). The optical signal optically couples into the waveguide 107. As a result, portions of the optical signal remain in the waveguide 105, and portions of the optical signal couple into the waveguide 107.

The cross-section C-C shows the waveguides 105 and 107 near the ends 204 and 208 of the waveguides 105 and 107. The waveguide 105 is positioned higher than the waveguide 107 on the z axis. Additionally, the waveguides 105 and 107 partially overlap each other when viewed along the z axis (e.g., portions of the waveguides 105 and 107 share the same coordinates on the y axis). The optical signal has optically coupled into the waveguide 107. The waveguide 105 has narrowed or tapered such that the waveguide 105 does not support any optical modes of the optical signal. As a result, the optical signal is fully contained in the waveguide 107. As seen in FIG. 7, when the optical signal is fully coupled into the waveguide 107, the optical signal has a two lobe mode in the waveguide 107. The mode multiplexer 102 then outputs the optical signal on the waveguide 107 with the two lobe mode. In this manner, the mode multiplexer 102 optically couples the optical signal in the waveguide 105 to the waveguide 107.

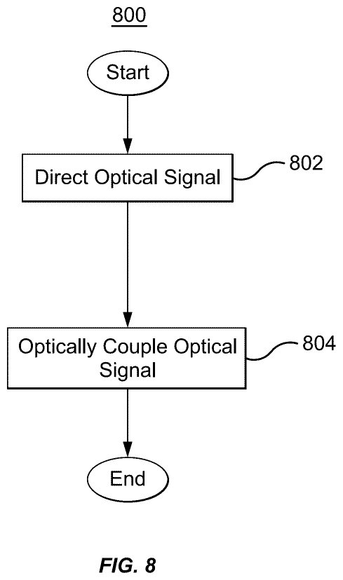

FIG. 8 is a flowchart of an example method 800 performed by the system 100 of FIG. 1. In particular embodiments, the mode multiplexer 102 performs the method 800. By performing the method 800, the mode multiplexer 102 reduces modal crosstalk and the length of the mode multiplexer 102 relative to existing mode multiplexers.

In block 802, the mode multiplexer 102 directs an optical signal through the waveguide 105. In block 804, the mode multiplexer 102 optically couples the optical signal in the waveguide 105 into the waveguide 107. The mode multiplexer 102 may then output the optical signal on the waveguide 107.

The waveguides 105 and 107 may be formed using different materials with different indexes of refraction. For example, the waveguide 105 may be formed using silicon nitride, and the waveguide 107 may be formed using silicon. Additionally, the waveguides 105 and 107 may be positioned such that the waveguides 105 and 107 gradually overlap each other along the lengths 210 and 212 of the waveguides 105 and 107. For example, at an end 202 where the optical signal was input into the waveguide 105, the waveguides 105 and 107 may not overlap each other when viewed along an axis. At an end 208 of the waveguide 107 where the optical signal is output, the waveguides 105 and 107 may partially overlap each other. The partial overlap of the waveguides 105 and 107 allows the optical signal to optically couple from the waveguide 105 into the waveguide 107.

Additionally, the widths of the waveguides 105 and 107 may change along the lengths 210 and 212 of the waveguides 105 and 107. For example, the waveguide 105 may taper or narrow moving from the end of 202 of the waveguide 105 towards an end 204 of the waveguide 105. The width of the waveguide 105 may narrow or taper such that the end 204 of the waveguide 105 does not support modes of an optical signal. As a result, an optical signal in the waveguide 105 fully couples into the waveguide 107 and does not remain in the waveguide 105 near the end 204 of the waveguide 105. As another example, the waveguide 107 may widen along the length 212 of the waveguide 107 moving from an end 206 of the waveguide 107 towards the end 208 of the waveguide 107. As a result of the wider end 208 of the waveguide 107, the waveguide 107 may support multiple modes of optical signals. Thus, an optical signal input into the waveguide 105 may have a single mode, but after that optical signal couples into the waveguide 107, the optical signal may have a two lobe mode in the waveguide 107.

In some embodiments, due to the different indexes of refraction of the waveguides 105 and 107 and the positioning and arrangement of the waveguides 105 and 107, the mode multiplexer 102 reduces modal crosstalk and the length of the mode multiplexer 102 relative to existing mode multiplexers. For example, the mode multiplexer 102 may provide the same or reduced modal crosstalk while having a length of around 60 μm as existing mode multiplexers with lengths of 200 to 400 μm.

In summary, the mode multiplexer 102 includes layered optical waveguides 105 and 107 formed using different materials. For example, the mode multiplexer 102 may include a first optical waveguide 105 and a second optical waveguide 107 positioned in a lower layer than the first optical waveguide 105. The first optical waveguide 105 and the second optical waveguide 107 may have different indexes of refraction. The first and second optical waveguides 105 and 107 may gradually overlap along the lengths 210 and 212 of the first and second optical waveguides 105 and 107. The first optical waveguide 105 may taper such that the first optical waveguide 105 does not support the mode of an optical signal at the output of the first optical waveguide 105. The second optical waveguide 107 may widen such that the second optical waveguide 107 supports multiple modes at the output of the second optical waveguide 107. An optical signal propagating through the first optical waveguide 105 may optically couple into the second optical waveguide 107 as the first optical waveguide 105 and the second optical waveguide 107 begin to gradually overlap.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In view of the foregoing, the scope of the present disclosure is determined by the claims that follow.

We claim:

1. A mode multiplexer comprising:
a first optical waveguide comprising a first end and a second end, wherein the first end is wider than the second end; and
a second optical waveguide comprising a third end, wherein the second optical waveguide has a higher index of refraction than the first optical waveguide, wherein the first optical waveguide and the second optical waveguide are arranged such that when the first optical waveguide and the second optical waveguide are viewed along a first axis:
a length of the first optical waveguide and a length of the second optical waveguide extend along a second axis orthogonal to the first axis;
the first end is non-overlapping with the third end; and
the second optical waveguide partially overlaps the second end.

2. The mode multiplexer of claim 1, wherein, when the first optical waveguide and the second optical waveguide are viewed along the first axis, the first end is aligned with the third end.

3. The mode multiplexer of claim 1, wherein the second optical waveguide comprises a fourth end wider than the third end.

4. The mode multiplexer of claim 3, wherein, when the first optical waveguide and the second optical waveguide are viewed along the first axis, the second end is aligned with the fourth end.

5. The mode multiplexer of claim 3, wherein an optical signal in the first optical waveguide optically couples into the second optical waveguide as the optical signal propagates from the first end towards the second end.

6. The mode multiplexer of claim 5, wherein the optical signal comprises a first mode when the optical signal is in the first optical waveguide, wherein the optical signal comprises a second mode when the optical signal is in the second optical waveguide, and wherein the second mode has more lobes than the first mode.

7. The mode multiplexer of claim 5, wherein a width of the second end prevents the optical signal from propagating to the second end.

8. The mode multiplexer of claim 1, wherein the first optical waveguide comprises silicon, and wherein the second optical waveguide comprises silicon nitride.

9. A method comprising:
directing an optical signal in a first optical waveguide comprising a first end and a second end, wherein the first end is wider than the second end; and
optically coupling the optical signal into a second optical waveguide comprising a third end, wherein the second optical waveguide has a higher index of refraction than the first optical waveguide, wherein the first optical waveguide and the second optical waveguide are arranged such that when the first optical waveguide and the second optical waveguide are viewed along a first axis:
a length of the first optical waveguide and a length of the second optical waveguide extend along a second axis orthogonal to the first axis;
the first end is non-overlapping with the third end; and
the second optical waveguide partially overlaps the second end.

10. The method of claim 9, wherein, when the first optical waveguide and the second optical waveguide are viewed along the first axis, the first end is aligned with the third end.

11. The method of claim 9, wherein the second optical waveguide comprises a fourth end wider than the third end.

12. The method of claim 11, wherein, when the first optical waveguide and the second optical waveguide are viewed along the first axis, the second end is aligned with the fourth end.

13. The method of claim 11, wherein the optical signal in the first optical waveguide optically couples into the second optical waveguide as the optical signal propagates from the first end towards the second end.

14. The method of claim 13, wherein the optical signal comprises a first mode when the optical signal is in the first optical waveguide, wherein the optical signal comprises a second mode when the optical signal is in the second optical waveguide, and wherein the second mode has more lobes than the first mode.

15. The method of claim 13, wherein a width of the second end prevents the optical signal from propagating to the second end.

16. The method of claim 9, wherein the first optical waveguide comprises silicon, and wherein the second optical waveguide comprises silicon nitride.

17. A mode multiplexer comprising:
a silicon nitride waveguide comprising a first end and a second end, wherein the first end is wider than the second end; and
a silicon waveguide, wherein the silicon nitride waveguide and the silicon waveguide are arranged such that an optical signal propagating from the first end towards the second end in the silicon nitride waveguide optically couples into the silicon waveguide, and wherein a width of the second end prevents the optical signal from propagating to the second end.

18. The mode multiplexer of claim 17, wherein the silicon waveguide comprises a third end and a fourth end wider than the third end.

19. The mode multiplexer of claim 18, wherein first end is aligned with the third end.

20. The mode multiplexer of claim 17, wherein the optical signal comprises a first mode when the optical signal is in the silicon nitride waveguide, wherein the optical signal comprises a second mode when the optical signal is in the silicon waveguide, and wherein the second mode has more lobes than the first mode.
